(19) United States
(12) Patent Application Publication
(10) Pub. No.: US 2010/0159878 A1
(43) Pub. Date: Jun. 24, 2010

(54) SYSTEM AND METHOD FOR PROTECTING PRIVATE INFORMATION OF UICC

(75) Inventors: Oun KIM, Seoul (KR); Hyungsuk KIM, Seoul (KR); Daecheol KIM, Seoul (KR); Namho SHIN, Seoul (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SMARTCARD LABORATORY INC., Seoul (KR)

(21) Appl. No.: 12/567,388

(22) Filed: Sep. 25, 2009

(30) Foreign Application Priority Data
Dec. 18, 2008 (KR) 10-2008-0129038

(51) Int. Cl. H04M 1/66

(52) U.S. Cl. 455/411

(57) ABSTRACT

Provided are a system and method for protecting private information of UICC. The system includes an initialization management server and a short message service center. The initialization management server generates an initialization station incoming message which includes an initialization command for initializing private information stored in a UICC according to an initialization request to the private information of the UICC, and uses a phone number assigned to the UICC as a reception number. The short message service center transmits the initialization station incoming message transmitted from the initialization management server to the phone number assigned to the UICC.

### CROSS-REFERENCE TO RELATED APPLICATIONS

This application claims priority under 35 U.S.C. §119 to Korean Patent Application No. 10-2008-129038, filed on Dec. 18, 2008, the disclosure of which is incorporated herein by reference in its entirety.

### TECHNICAL FIELD

The present invention relates to a system and method for protecting private information of Universal Integrated Circuit Card (UICC), and in particular, to a system and method for protecting private information of UICC, which initialize private information stored in a UICC according to a private information initialization request, and thus can protect the private information stored in the UICC.

### BACKGROUND

When a mobile station is lost, a user may deactivate a phone service by reporting the lost station to a mobile communication service provider. However, because the finder of the lost station can read private information that is stored in the lost station even after deactivating the phone service, a mobile station user's private information may be disclosed. Particularly, since mobile stations recently perform various functions, when the mobile station is lost, a user's privacy such as a photograph album may be infringed and the user's financial information such as a banking service may be disclosed to the finder of the lost station. Consequently, the loss of the mobile station can do serious damage to a user.

For solving these limitations, a Personal Identification Number (PIN) may be used when using a UICC such as a Universal Subscriber Identity Module (USIM) card, a Subscriber Identification Module (SIM) card, a Removable User Identification Module (RUIM) card or a User Identity Module (UIM) card. A user inputs a PIN to pass through the authentication of a UICC and can thereby use a mobile station and the UICC. However, because a PIN authentication scheme is complicated and users (which cannot skillfully manipulate electronic devices) do not set a PIN or set the PIN as continuous numbers or a specific number that can be easily recognized to other users even though they set the PIN, private information stored in the UICC may be disclosed to other users.

### SUMMARY

Accordingly, the present invention provides a system and method for protecting private information of UICC, in which an initialization management server generates an initialization station incoming message including an initialization command for initializing private information stored in the UICC when a private information initialization request is inputted, and thus an initialization card application toolkit that receives the message can initialize the private information stored in the UICC.

The present invention also provides a system and method for protecting private information of UICC, in which an initialization card application toolkit extracts an initialization command for initializing private information stored in the UICC from an initialization station incoming message to execute the extracted command when the initialization station incoming message is received, and thus a user can prevent the private information from being disclosed to other users by initializing the private information stored in the UICC when losing a mobile station, thereby protecting the private information.

The present invention also provides a system and method for protecting private information of UICC, which further include a backup server that receives and stores private information for initializing over a communication network before initializing the UICC and transmits the stored private information when a user's request is inputted, enabling the user to again obtain the private information stored in the UICC when the user desires it.

According to an aspect, there is provided a system for protecting private information of UICC, including: an initialization management server generating an initialization station incoming message which includes an initialization command for initializing private information stored in a UICC according to an initialization request to the private information of the UICC, and uses a phone number assigned to the UICC as a reception number; and a short message service center transmitting the initialization station incoming message transmitted from the initialization management server to the phone number assigned to the UICC.

According to another aspect, there is provided a system for protecting private information of UICC, including: a mobile station receiving a short message service; and a UICC included in the mobile station, storing a user's private information, wherein: the mobile station includes a UICC message transmission module which transmits the initialization station incoming message to the UICC when receiving an initialization station incoming message which includes an initialization command for initializing the private information stored in the UICC, according to a private information initialization request, and the UICC includes an initialization card application toolkit which extracts the initialization command from the initialization station incoming message when receiving the initialization station incoming message, and initializes the private information stored in the UICC according to the initialization command.

According to another embodiment, there is provided a system for protecting private information of UICC, including: an initialization management server generating an initialization station incoming message which includes an initialization command for initializing private information stored in a UICC according to a private information initialization request, and uses a phone number assigned to the UICC as a reception number; a short message service center transmitting the initialization station incoming message transmitted from the initialization management server to the phone number assigned to the UICC; a mobile station receiving the initialization station incoming message; and a UICC included in the mobile station, receiving the initialization station incoming message, wherein the UICC includes an initialization card application toolkit which extracts the initialization command from the initialization station incoming message when receiving the initialization station incoming message, and initializes the private information stored in the UICC according to the initialization command.

In the system for protecting private information of UICC, the initialization station incoming message may be a short message which includes at least one of a Command Packet Identifier (CPI) field, a Command Packet Length (CPL) field, a Command Header Identifier (CHI) field, a Command Header Length (CHL) field, a Security Parameter Indicator (SPI) field, a Ciphering Key Identifier (KIC) field, a Key Identifier (KID) field, a Toolkit Application Reference (TAR) field, a Counter (CNTR) field, a Padding counter (PCNTR) field, a Secured Data field, a Redundancy Check (RC) field, a Cryptographic Checksum (CC) field and a Digital Signature (DS) field, the initialization card application toolkit may be designated in the Toolkit Application Reference (TAR) field, and the Secured Data field may include an execution command for executing the initialization card application toolkit.

In the system for protecting private information of UICC, the private information may include at least one of an address book, communication information, a Short Message Service (SMS), a Multimedia Message Service (MMS), photographs and a private schedule.

In the system for protecting private information of UICC, the initialization station incoming message may further include data for a category to initialize among the private information.

In the system for protecting private information of UICC, the UICC may further include a private information transmission module for transmitting the private information before initializing the private information stored in the UICC. The system for protecting private information of UICC may further include a backup server receiving and backing up the private information which is transmitted over a communication network.

In the system for protecting private information of UICC, the backup server may include a private information recovery module transmitting the private information, which is backed up to the backup server, to the UICC or another UICC when a user's request is inputted.

In the system for protecting private information of UICC, the UICC may further include an execution result management module executing the initialization card application toolkit to initialize the UICC, and transmitting an execution result based on the private information initialization request to the initialization management server.

In the system for protecting private information of UICC, the mobile station may further include a display module displaying a message in which the private information is initialized and is not stored in the UICC, after the initialization card application toolkit is executed.

According to another embodiment, there is provided a method for protecting private information of UICC in a system which includes an initialization management server, a short message service center, a mobile station and a UICC included in the mobile station, the method including: generating an initialization station incoming message which includes an initialization command for initializing private information stored in the UICC according to an initialization request to the private information of the UICC, and uses a phone number assigned to the UICC as a reception number, in the initialization management server; transmitting the initialization station incoming message to the short message service center, in the initialization management server; receiving the initialization station incoming message to transmit the received message to the mobile station, in the short message service center; transmitting the initialization station incoming message to the UICC, in the mobile station receiving; and receiving the initialization station incoming message, and executing an initialization card application toolkit stored in the UICC to initialize the private information stored in the UICC, in the UICC.

In the method for protecting private information of UICC, the receiving of the initialization station incoming message may include: transmitting the private information stored in the UICC to the backup server before executing the initialization card application toolkit, in the UICC; and backing up and storing the private information, in the backup server.

The method for protecting private information of UICC may further include transmitting an executing result based on the private information initialization request to the initialization management server after the receiving of the initialization station incoming message, in the UICC.

In the method for protecting private information of UICC, after the receiving of the initialization station incoming message, the backup server may transmit the private information stored in the backup server to the UICC or another UICC when a user's request is inputted.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram illustrating a system for protecting private information of UICC according to an embodiment of the present invention.

FIG. 2 is a detailed block diagram illustrating a mobile station and a UICC according to an embodiment of the present invention.

FIG. 3 is a block diagram illustrating an initialization station incoming message according to an embodiment of the present invention.

FIG. 4 is an exemplary diagram illustrating the execution of an initialization card application toolkit before and after, according to an embodiment of the present invention.

FIG. 5 is a flow chart illustrating a method for protecting private information of UICC according to an embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

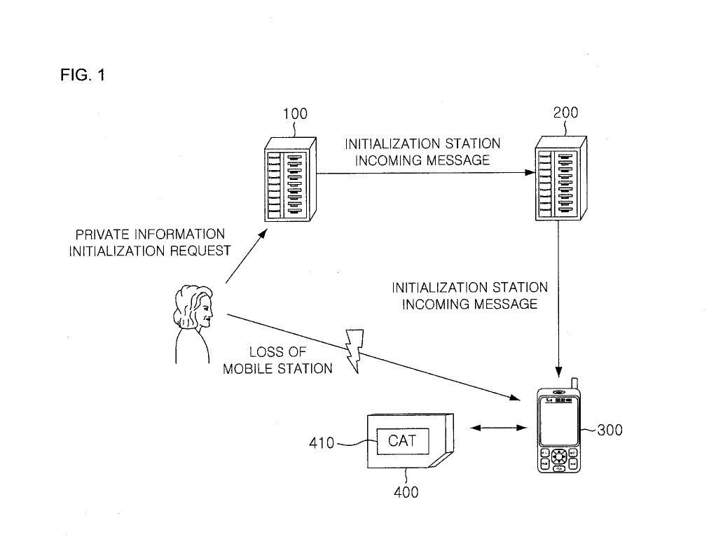

FIG. 1 is a block diagram illustrating a system for protecting private information of UICC according to an embodiment of the present invention.

Referring to FIG. 1, a system for protecting private information of UICC according to an embodiment of the present invention may include an initialization management server 100, a Short Message Service Center (SMSC) 200, and a mobile station 300 including a UICC 400.

The initialization management server 100 generates an initialization station incoming message “Initializing_SMS Deliver Message” to transmit the generated message to the short message service center 200 when a private information initialization request is inputted. The initialization management server 100 may be connected to the customer service center of a mobile communication service provider and be thereby operated. In this case, when a user reports the loss of a mobile station, the initialization management server 100 may automatically generate the initialization station incoming message to transmit the generated message. As a separate server, the initialization management server 100 may be operated. Moreover, the initialization management server 100 may be operated as a server independent of the customer service center of the mobile communication service provider. In this case, when a private information initialization request is inputted from the user independently from the loss report of the mobile station, the initialization management server 100 may generate the initialization station incoming message to transmit the generated message to the short message service center 200.

The initialization station incoming message includes an initialization command for initializing private information stored in a specific UICC, and is one that uses a phone number assigned to the UICC as a reception number.

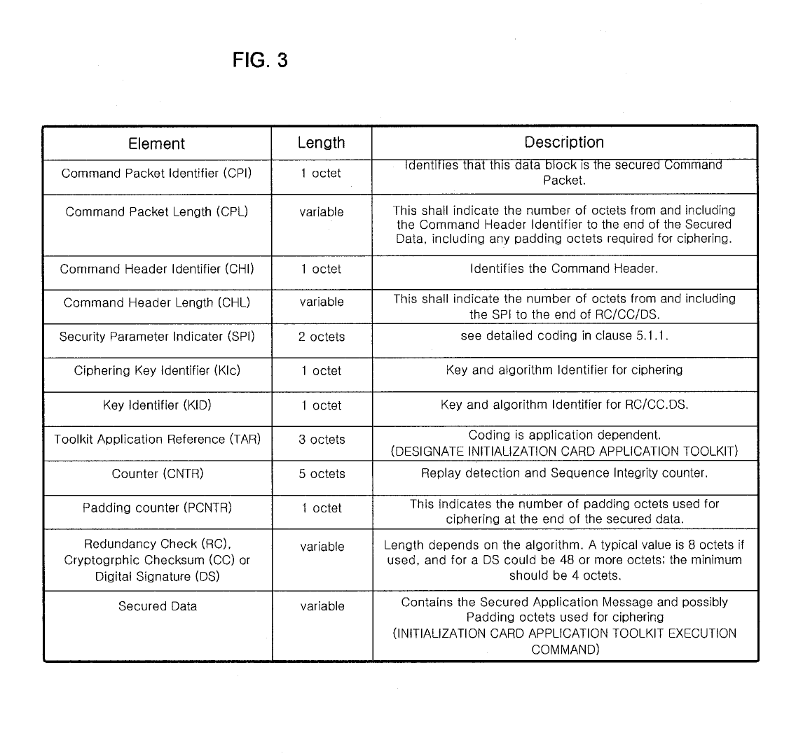

The initialization station incoming message, as illustrated in FIG. 3, is a short message that is composed of any one of a Command Packet Identifier (CPI) field, a Command Packet Length (CPL) field, a Command Header Identifier (CHI) field, a Command Header Length (CHL) field, a Security Parameter Indicator (SPI) field, a Ciphering Key Identifier (KIC) field, a Key Identifier (KID) field, a Toolkit Application Reference (TAR) field, a Counter (CNTR) field, a Padding counter (PCNTR) field, a Secured Data field, a Redundancy Check (RC) field, a Cryptographic Checksum (CC) field and a Digital Signature (DS) field. In particular, in the Toolkit Application Reference (TAR) field, an initialization card application toolkit 410 for executing is designated. Moreover, the secured data field includes an execution command for executing the initialization card application toolkit 410.

Private information, which is deleted from the UICC 400 and is to be initialized, may be any one of an address book, communication information, a Short Message Service (SMS), a Multimedia Message Service (MMS), photographs and a private schedule. At this point, the initialization station incoming message may further include data for a category to initialize among the private information. For example, a user may set the initialization station incoming message in order to delete only data for the SMS and the MMS among the private information. In this case, the initialization station incoming message includes relevant data, and the initialization card application toolkit may delete only the SMS and the MMS from the UICC 400 to initialize the private information.

The short message service center 200 transmits the initialization station incoming message, transmitted from the initialization management server 100, to a phone number assigned to the UICC 400.

The short message service center 200 may perform a store and forward message switch function. That is, this is a communication service that forwards data between mobile stations or between a mobile station and a Short Message Entity (SME) in a character type having a limited magnitude, and is a system that stores a short message (which is transmitted to a called subscriber incapable of receiving at an arbitrary moment) until the called subscriber may receive and forwards the stored message to the called subscriber and/or a called subscriber under phone.

The mobile station 300 may receive a short message service, and particularly receives an initialization station incoming message.

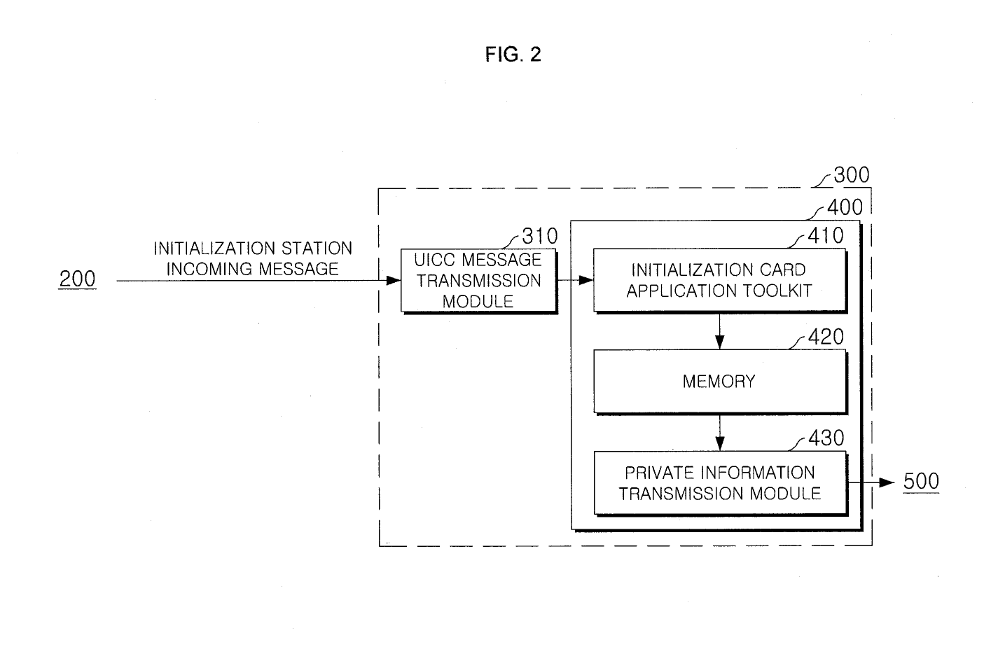

Referring to FIG. 2, the mobile station 300 may further include a UICC message transmission module 310. When the UICC message transmission module 310 receives an initialization station incoming message “Initializing_SMS Deliver Message”, it transmits the initialization station incoming message to the UICC 400. More specifically, the UICC message transmission module 310 directly transmits the initialization station incoming message to the initialization card application toolkit 410 of the UICC 400.

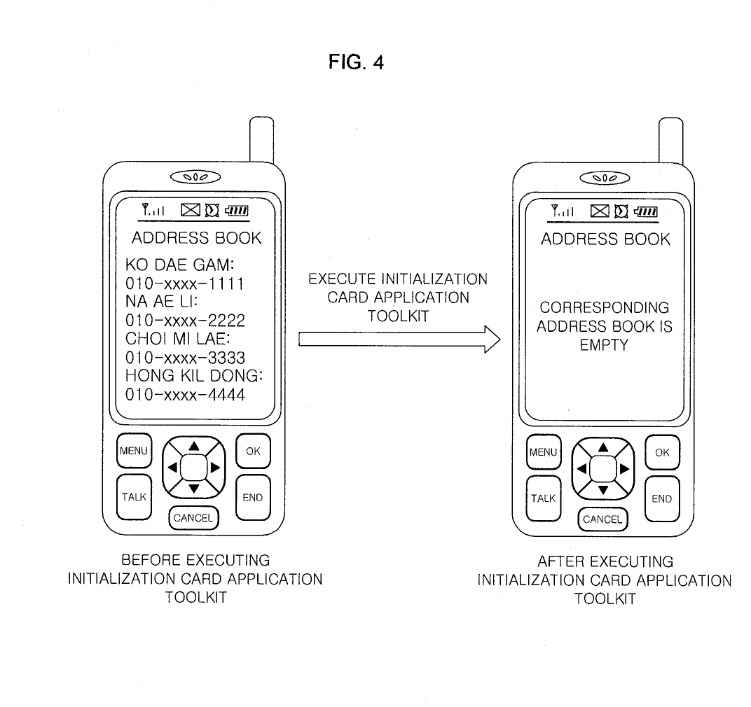

The mobile station 300 may further include a display module. When private information is initialized after the initialization card application toolkit 410 is executed, the display module may display a message in which private information is not stored in the UICC 400. As illustrated in FIG. 4, the initialization card application toolkit 410 is executed and thereby the private information is deleted and initialized, and when a finder desires to read an address book, the UICC 400 may display a message, for example, “a corresponding address book is empty, in which the private information is not stored.

The UICC 400 stores a user's private information, and is included in the mobile station 300 to receive an initialization station incoming message.

The UICC 400 is the abbreviation of a universal IC card, and as a multifunction smartcard that is used in subscriber authentication for the stable network access of potable Internet and provides various communication and financial addition services, it is included in the mobile station 300. The UICC 400, for example, may be a USIM card, a SIM card, a RUIM card or a UIM card.

A Card Application Toolkit (CAT) is an applet that operates in a UICC, for example, refers to a SIM Application Toolkit (SAT) applet, a USIM Application Toolkit (USAT) applet and a UIM ToolKit (UTK) applet.

When the initialization card application toolkit 410 receives an initialization station incoming message from the mobile station 300, it extracts an initialization command from the initialization station incoming message and initializes private information stored in the UICC 400 according to an initialization command.

The initialization card application toolkit 410 extracts the initialization command for initializing the private information stored in the UICC from the initialization station incoming message to execute the extracted command when the initialization station incoming message is received, and thus a user can prevent the private information from being disclosed to other users by initializing the private information stored in the UICC 400 when losing a mobile station, thereby protecting the private information.

Moreover, the UICC 400 may further include an execution result transmission module. The execution result transmission module executes the initialization card application toolkit 410 to initialize the UICC 400, and transmits an execution result based on a private information initialization request to the initialization management server 100.

The system for protecting private information may further include a backup server 500. The backup server 500 receives private information transmitted over a communication network and performs backup.

At this point, the UICC 400 may further include a private information transmission module 430 that transmits private information to the backup server 500 over a communication network before initializing private information stored in the UICC 400, and a private information recovery module 430. When a user's request is inputted, the private information recovery module 430 transmits private information, backed up to the backup server 500, to the UICC 400 or another UICC different from a lost UICC.

According to this embodiment, the system receives and stores private information for initializing over a communication network before initializing a UICC and transmits the stored private information when a user's request is inputted, enabling the user to again obtain the private information stored in the UICC when the user desires it. That is, since a mobile station user stores much private information such as phone numbers, anniversaries and plans in a mobile station or a UICC included in it but does not separately store the private information, it cannot use the private information when the UICC is lost. In this case, if the private information of the UICC is initialized, the user's private information is not disclosed to the finder of the lost UICC, but all the private information stored in the lost UICC is deleted and thereby the user cannot again find the lost UICC or recover the private information stored in the lost UICC through other medium. Accordingly, the system backs up the private information to the backup server 500 before initializing the private information stored in the UICC, and when the user desires the private information, the system enables the user to use the backed-up private information through user authentication.

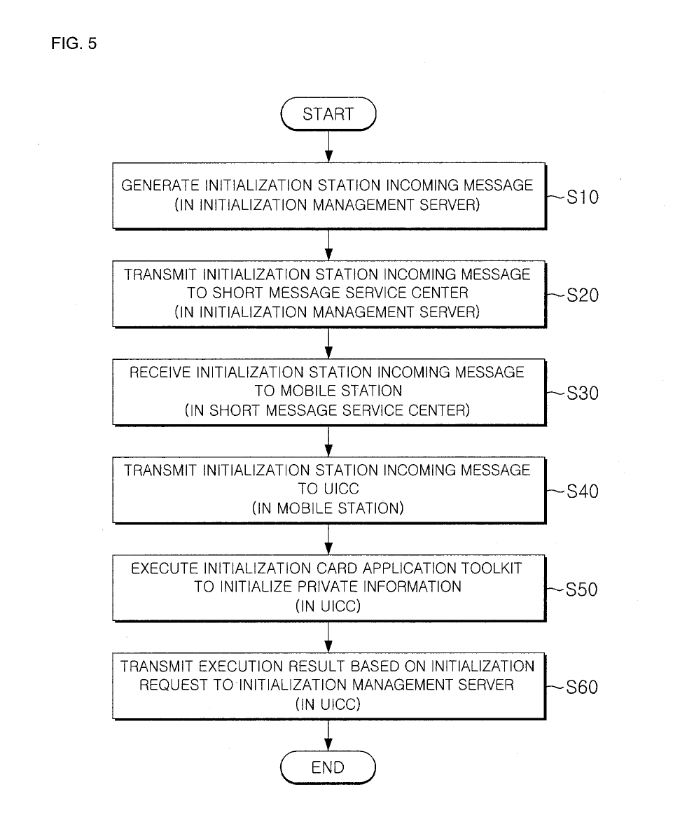

FIG. 5 is a flow chart illustrating a method for protecting private information of UICC according to an embodiment of the present invention.

First, the system performs a first operation S10 in which the initialization management server 100 generates an initialization station incoming message according to the private information initialization request of a UICC. The initialization station incoming message is a message that includes an initialization command for initializing private information stored in the UICC 400 and uses a phone number assigned to the UICC 400 as a reception number. The initialization station incoming message, as illustrated in FIG. 3, is a short message that is composed of any one of a Command Packet Identifier (CPI) field, a Command Packet Length (CPL) field, a Command Header Identifier (CHI) field, a Command Header Length (CHL) field, a Security Parameter Indicator (SPI) field, a Ciphering Key Identifier (KIC) field, a Key Identifier (KID) field, a Toolkit Application Reference (TAR) field, a Counter (CNTR) field, a Padding counter (PCNTR) field, a Secured Data field, a Redundancy Check (RC) field, a Cryptographic Checksum (CC) field and a Digital Signature (DS) field. In particular, in the Toolkit Application Reference (TAR) field, the initialization card application toolkit 410 for executing is designated. Moreover, the secured data field includes an execution command for executing the initialization card application toolkit 410.

The system performs a second operation S20 in which the initialization management server 100 transmits the initialization station incoming message to the short message service center 200.

The system performs a third operation S30 in which the short message service center 200 receives the initialization station incoming message to transmit the received message to the mobile station 300.

The short message service center 200 transmits the initialization station incoming message to a phone number assigned to the UICC 400.

The system performs a fourth operation S40 in which the mobile station 300 transmits the initialization station incoming message received from the short message service center 200 to the UICC 400.

The system performs a fifth operation S50 in which the UICC 400 receives the initialization station incoming message, and executes the initialization card application toolkit 410 stored in it to initialize the private information stored in the UICC 400.

The fifth operation S50 may include a first sub-operation in which the UICC 400 transmits the private information stored in the UICC 400 to the backup server 500 before executing the initialization card application toolkit 410, and a second sub-operation in which the backup server 500 backs up and stores the private information.

After the fifth operation S50, the system may further perform a third sub-operation in which the backup server 500 transmits the private information stored in it to the UICC 400 or another UICC instead of the UICC 400 that stored the private information, when a user's request is inputted.

According this embodiment, the method receives and stores the private information for initializing over the communication network before initializing the UICC and transmits the stored private information when a user's request is inputted, enabling the user to again obtain the private information stored in the UICC when the user desires it.

After the fifth operation S50, finally, the system may further perform a sixth operation S60 in which the UICC 400 transmits an execution result based on a private information initialization request to the initialization management server 100.

In the system and method for protecting private information of UICC according to embodiments of the present invention, the initialization management server generates the initialization station incoming message including the initialization command for initializing private information stored in the UICC when a private information initialization request is inputted, and thus the initialization card application toolkit that receives the message can initialize the private information stored in the UICC.

In the system and method for protecting private information of UICC according to embodiments of the present invention, the initialization card application toolkit extracts the initialization command for initializing the private information stored in the UICC from the initialization station incoming message to execute the extracted command when the initialization station incoming message is received, and thus a user can prevent the private information from being disclosed to other users by initializing the private information stored in the UICC when losing a mobile station, thereby protecting the private information.

The system and method for protecting private information of UICC according to embodiments of the present invention further include the backup server that receives and stores the private information for initializing over the communication network before initializing the UICC and transmits the stored private information when a user's request is inputted, enabling the user to again obtain the private information stored in the UICC when the user desires it.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A system for protecting private information of Universal Integrated Circuit Card (UICC), comprising:
an initialization management server generating an initialization station incoming message which comprises an initialization command for initializing private information stored in a UICC according to an initialization request to the private information of the UICC, and uses a phone number assigned to the UICC as a reception number; and
a short message service center transmitting the initialization station incoming message transmitted from the initialization management server to the phone number assigned to the UICC.

2. A system for protecting private information of Universal Integrated Circuit Card (UICC), comprising:
a mobile station receiving a short message service; and
a UICC inserted in the mobile station, storing a user's private information,
wherein:
the mobile station comprises a UICC message transmission module which transmits the initialization station incoming message to the UICC when receiving an initialization station incoming message which comprises an initialization command for initializing the private information stored in the UICC, according to a private information initialization request, and
the UICC comprises an initialization card application toolkit which extracts the initialization command from the initialization station incoming message when receiving the initialization station incoming message, and initializes the private information stored in the UICC according to the initialization command.

3. A system for protecting private information of Universal Integrated Circuit Card (UICC), comprising:
an initialization management server generating an initialization station incoming message which comprises an initialization command for initializing private information stored in a UICC according to a private information initialization request, and uses a phone number assigned to the UICC as a reception number;
a short message service center transmitting the initialization station incoming message transmitted from the initialization management server to the phone number assigned to the UICC;
a mobile station receiving the initialization station incoming message; and
a UICC comprised in the mobile station, receiving the initialization station incoming message,
wherein the UICC comprises an initialization card application toolkit which extracts the initialization command from the initialization station incoming message when receiving the initialization station incoming message, and initializes the private information stored in the UICC according to the initialization command.

4. The system of claim 2, wherein:
the initialization station incoming message is a short message which comprises at least one of a Command Packet Identifier (CPI) field, a Command Packet Length (CPL) field, a Command Header Identifier (CHI) field, a Command Header Length (CHL) field, a Security Parameter Indicator (SPI) field, a Ciphering Key Identifier (KIC) field, a Key Identifier (KID) field, a Toolkit Application Reference (TAR) field, a Counter (CNTR) field, a Padding counter (PCNTR) field, a Secured Data field, a Redundancy Check (RC) field, a Cryptographic Checksum (CC) field and a Digital Signature (DS) field,
the initialization card application toolkit is designated in the Toolkit Application Reference (TAR) field, and
the Secured Data field comprises an execution command for executing the initialization card application toolkit.

5. The system of claim 1, wherein the private information comprises at least one of an address book, communication information, a Short Message Service (SMS), a Multimedia Message Service (MMS), photographs and a private schedule.

6. The system of claim 5, wherein the initialization station incoming message further comprises data for a category to initialize among the private information.

7. The system of claim 3, wherein:
the UICC further comprises a private information transmission module for transmitting the private information before initializing the private information stored in the UICC, and
the system for protecting private information further comprises a backup server receiving and backing up the private information which is transmitted over a communication network.

8. The system of claim 7, wherein the backup server comprises a private information recovery module transmitting the private information, which is backed up to the backup server, to the UICC or another UICC when a user's request is inputted.

9. The system of claim 3, wherein the UICC further comprises an execution result management module executing the initialization card application toolkit to initialize the UICC, and transmitting an execution result based on the private information initialization request to the initialization management server.

10. The system of claim 2, wherein the mobile station further comprises a display module displaying a message in which the private information is initialized and is not stored in the UICC, after the initialization card application toolkit is executed.

11. A method for protecting private information of Universal Integrated Circuit Card (UICC) in a system which includes an initialization management server, a short message service center, a mobile station and a UICC included in the mobile station, the method comprising:
generating an initialization station incoming message which comprises an initialization command for initializing private information stored in the UICC according to an initialization request to the private information of the UICC, and uses a phone number assigned to the UICC as a reception number, in the initialization management server;
transmitting the initialization station incoming message to the short message service center, in the initialization management server;
receiving the initialization station incoming message to transmit the received message to the mobile station, in the short message service center;
transmitting the initialization station incoming message to the UICC, in the mobile station receiving; and
receiving the initialization station incoming message, and executing an initialization card application toolkit stored in the UICC to initialize the private information stored in the UICC, in the UICC.

12. The method of claim 11, wherein:
the initialization station incoming message is a short message which comprises at least one of a Command Packet Identifier (CPI) field, a Command Packet Length (CPL) field, a Command Header Identifier (CHI) field, a Command Header Length (CHL) field, a Security Parameter Indicator (SPI) field, a Ciphering Key Identifier (KIC) field, a Key Identifier (KID) field, a Toolkit Application Reference (TAR) field, a Counter (CNTR) field, a Padding counter (PCNTR) field, a Secured Data field, a Redundancy Check (RC) field, a Cryptographic Checksum (CC) field and a Digital Signature (DS) field,
the initialization card application toolkit is designated in the Toolkit Application Reference (TAR) field, and
the Secured Data field comprises an execution command for executing the initialization card application toolkit.

13. The method of claim 11, wherein the receiving of the initialization station incoming message comprises:
transmitting the private information stored in the UICC to the backup server before executing the initialization card application toolkit, in the UICC; and
backing up and storing the private information, in the backup server.

14. The method of claim 11, further comprising transmitting an executing result based on the private information initialization request to the initialization management server after the executing of an initialization card application toolkit, in the UICC.

15. The method of claim 13, wherein after the backing up and storing of the private information, the backup server transmits the private information stored in the backup server to the UICC or another UICC when a user's request is inputted.

16. The system of claim 3, wherein:
the initialization station incoming message is a short message which comprises at least one of a Command Packet Identifier (CPI) field, a Command Packet Length (CPL) field, a Command Header Identifier (CHI) field, a Command Header Length (CHL) field, a Security Parameter Indicator (SPI) field, a Ciphering Key Identifier (KIC) field, a Key Identifier (KID) field, a Toolkit Application Reference (TAR) field, a Counter (CNTR) field, a Padding counter (PCNTR) field, a Secured Data field, a Redundancy Check (RC) field, a Cryptographic Checksum (CC) field and a Digital Signature (DS) field,
the initialization card application toolkit is designated in the Toolkit Application Reference (TAR) field, and
the Secured Data field comprises an execution command for executing the initialization card application toolkit.

17. The system of claim 2, wherein the private information comprises at least one of an address book, communication information, a Short Message Service (SMS), a Multimedia Message Service (MMS), photographs and a private schedule.

18. The system of claim 3, wherein the private information comprises at least one of an address book, communication information, a Short Message Service (SMS), a Multimedia Message Service (MMS), photographs and a private schedule.

19. The system of claim 3, wherein the mobile station further comprises a display module displaying a message in which the private information is initialized and is not stored in the UICC, after the initialization card application toolkit is executed.
